(19) United States
(12) Patent Application Publication
(10) Pub. No.: US 2006/0092115 A1
(43) Pub. Date: May 4, 2006

(54) Display apparatus

(75) Inventors: Takaaki Matono, Yokohama (JP); Mutsumi Suzuki, Kodaira (JP); Toshimitsu Watanabe, Yokohama (JP); Katsumi Ashizawa, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/213,075

(22) Filed: Aug. 26, 2005

(30) Foreign Application Priority Data
Oct. 29, 2004 (JP) 2004-315001

(51) Int. Cl. G09G 3/36

(52) U.S. Cl. 345/90

(57) ABSTRACT

The invention intends to realize long lifetime of electron-emitter elements and a display apparatus by preferably eliminating charges accumulated in the electron-emitter elements. The display apparatus of the invention has: a non-display period extending circuit for extending a non-display period of an input video signal to a period longer than the non-display period of the input video image and outputting the extended signal; a plurality of electron-emitter elements for emitting electrons on the basis of the video signal outputted from the non-display period extending circuit; and a scan driver having a pulse applying circuit for applying a pulse signal to the electron-emitter elements in the non-display period of the video signal extended by the non-display period extending circuit. A pulse width of the pulse signal is set to be longer in accordance with the extended non-display period.

### INCORPORATION BY REFERENCE COPY

The present application claims priority from Japanese application JP2004-315001 filed on Oct. 29, 2004, the content of which is hereby incorporated by reference into this application.

### BACKGROUND OF THE INVENTION

The invention relates to a display apparatus for forming a video image by colliding electrons emitted from an electron-emitter element to phosphor.

In a display apparatus for forming a video image by colliding electrons emitted from an electron-emitter element to phosphor, there is a case where charges are accumulated in the electron-emitter element. Such accumulated charges are one of factors of deterioration (reduction of lifetime) of the electron-emitter element.

As a conventional technique for preventing the accumulation of the charges by emitting the charges accumulated in the electron-emitter element, for example, a technique disclosed in JP-A-11-095716 has been known. This Patent Document 1 discloses the technique for preventing the accumulation of the charges by applying a pulse having a reverse polarity (hereinbelow, referred to as a reverse polarity pulse) opposite to that of a scan pulse for scanning the electron-emitter element to the electron-emitter element for a vertical blanking period.

### SUMMARY OF THE INVENTION

The operation to apply the reverse polarity pulse to the electron-emitter element as disclosed in Patent Document 1 denotes that a bias in the reverse direction is applied to the electron-emitter element. A withstanding voltage against the reverse-directional bias applied to the electron-emitter element is equal to, for example, about a few V. It is necessary to set the voltage of the reverse polarity pulse to be lower than such a withstanding voltage.

Therefore, according to the technique disclosed in Patent Document 1, the reverse polarity pulse of a relatively low voltage which is equal to or lower than the withstanding voltage is applied in a relatively short period of time as a vertical blanking period. Therefore, it is difficult to preferably emit the accumulated charges. In the display apparatus using the electron-emitter elements, it is important to preferably emit the accumulated charges of the electron-emitter elements, thereby extending lifetime of the electron-emitter elements and extending lifetime of the display apparatus.

The invention is made in consideration of the above problem and intends to provide a display apparatus having long lifetime.

To accomplish the above object, the invention is characterized by controlling a pulse width of a pulse signal which is applied to the electron-emitter element for a non-display period of a video signal such as a vertical blanking period or the like. Specifically speaking, the non-display period of the video signal which is supplied to the electron-emitter element is set to be longer than a non-display period (vertical blanking period) of an input video signal such as a television signal, thereby increasing the pulse width of the pulse signal in accordance with the extended period. It is preferable that such a pulse signal has a reverse polarity opposite to that of a selection voltage for selecting the electron-emitter elements on a row unit basis and its pulse width is longer than the non-display period of the input video signal.

According to the construction of the invention, while the pulse signal having a relatively low voltage that is equal to or lower than the withstanding voltage against the reverse-directional bias applied to the electron-emitter element is used, by controlling so as to increase its pulse width, the applied period of the pulse signal to the electron-emitter element can be extended. According to the invention, therefore, the accumulated charges can be preferably emitted. Further, if the non-display period of the video signal which is supplied to the electron-emitter element is extended, the pulse width of the pulse signal can be increased in correspondence to such an extended period and the emitting effect of the accumulated charges is further enhanced.

The pulse width of the pulse signal can be also changed in accordance with a kind of input video signal, for example, in accordance with whether the input video signal is a standard television signal or a high-definition television signal (HDTV signal). For example, in the case of the standard TV signal, the pulse width of the pulse signal is set to be longer than 1.428 [msec] as its vertical blanking period. In the case of the HDTV signal, the pulse width of the pulse signal can be set to be longer than 0.666 [msec] as its vertical blanking period.

As mentioned above, according to the invention, the long lifetime of the display apparatus having the electron-emitter elements can be realized.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the first embodiment of a display apparatus according to the invention;

FIG. 2 is a diagram showing operation waveforms of a selection signal and a reverse polarity signal;

FIGS. 3A and 3B are diagrams for explaining a concept of a method of extending a non-display period;

FIGS. 4A and 4B are diagrams for explaining the operation to extend a vertical non-display period in the first embodiment;

FIGS. 5A and 5B are diagrams showing the second embodiment of a display apparatus according to the invention;

FIGS. 6A and 6B are diagrams showing the third embodiment of a display apparatus according to the invention; and

FIG. 7 is a diagram showing the fourth embodiment of a display apparatus according to the invention.

### DETAILED DESCRIPTION OF THE EMBODIMENTS

The embodiment of the invention will be described hereinbelow with reference to the drawings. Component elements having common functions in the drawings are designated by the same reference numerals and their overlapped explanation of the component elements described once is omitted in order to avoid complexity.

There are various kinds of pixels as electron-emitter element pixels as electron emitters which are used for an electron-emitter type display apparatus (also referred to as FED). For example, a surface-conduction type, carbon-nanotube type, a spint type, an MIM (metal-insulator-metal) type, an MIS (metal-insulator-semiconductor) type, and the like exist. In the MIM type and the MIS type, there is a pixel using a stacked film of an insulator and a semiconductor in place of an insulating layer, that is, there is a pixel with a 4-layer structure of metal-insulating layer-semiconductor layer-metal (or semiconductor). The MIM type and the MIS type are also called a thin-film type electron-emitter element and since the insulating layer is sandwiched between the two metal layers or between the metal layer and the semiconductor layer, such an element has a capacitive structure in a manner similar to a capacitor. Therefore, according to the thin-film type electron-emitter element, the charges are more liable to be accumulated in (insulating layer) the element as compared with other electron-emitter elements of the surface-conduction type and the like. Thus, it is more necessary to emit the accumulated charges is large, particularly, for the thin-film type electron-emitter element. Therefore, the following embodiments will be described with respect to a display apparatus, as an example, using the thin-film type electron-emitter elements as electron-emitter elements. However, the invention can be similarly applied to other types of electron-emitter elements so long as the electrons are accumulated in the element, and an effect similar to that of the invention is also obtained.

### Embodiment 1

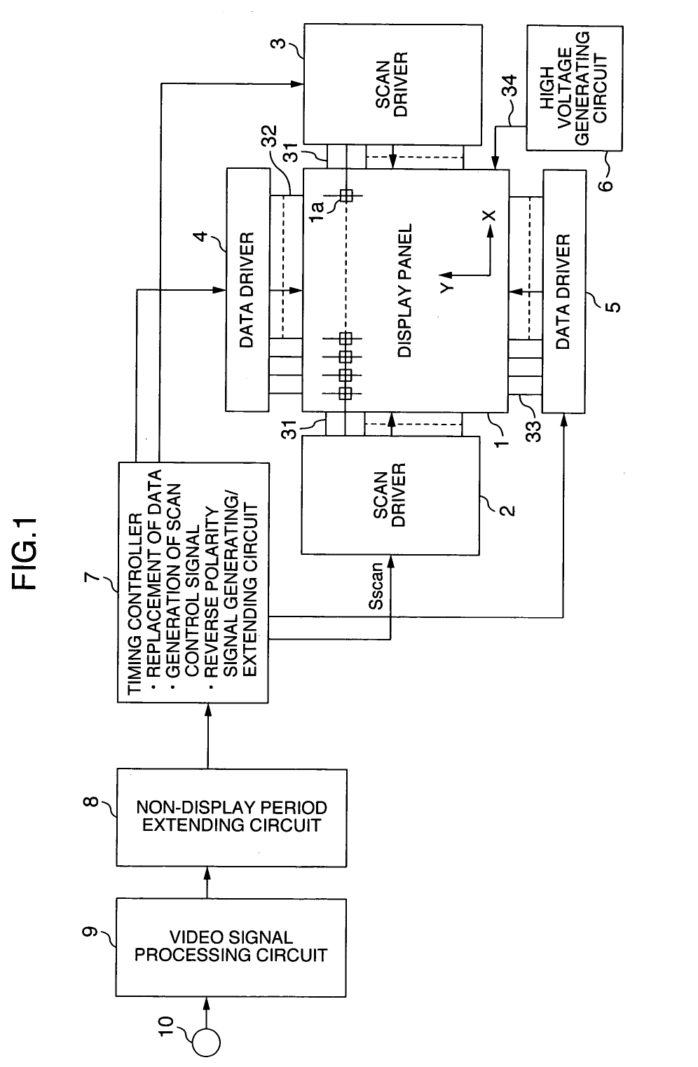

FIG. 1 is a block diagram showing the first embodiment of a display apparatus according to the invention. The embodiment is characterized by having: a non-display period extending circuit 8 for extending a non-display period; and a timing controller 7 having a reverse polarity signal generating function and an extending function for extending a reverse polarity signal period of its reverse polarity signal.

As shown in FIG. 1, the display apparatus of the embodiment comprises: a display panel 1 in which a plurality of thin-film type electron-emitter elements are placed in a matrix form; scan drivers (scan line drive circuits) 2 and 3 and data drivers (data line drive circuits) 4 and 5 for driving the display panel 1; a high voltage generating circuit 6 for generating a high acceleration voltage which is applied to the display panel 1; a video signal processing circuit 9 for executing a predetermined signal process to a video signal which is inputted from a video input terminal 10 so that a video image corresponding to the video signal can be displayed by the display panel 1; the non-display period extending circuit 8 for extending the non-display period; and the timing controller 7 for controlling the scan drivers 2 and 3 and the data drivers 4 and 5 on the basis of the input video signal.

First, the display panel 1, the scan drivers 2 and 3 as drive circuits thereof, the data drivers 4 and 5, and the high voltage generating circuit 6 will be described.

The display panel 1 is a video display panel of a passive matrix type and has a rear substrate (not shown) and a front substrate (not shown) which face each other. On the rear substrate, a plurality of data lines 32 and 33 extending in the column direction (Y direction as a display screen vertical direction) are placed in the row direction (X direction as a display screen horizontal direction) and a plurality of scan lines 31 extending in the row direction (X direction) are placed in the column direction (Y direction). A thin-film type electron-emitter element (hereinafter, simply referred to as an “electron-emitter element”) 1a is placed in each crossing portion of a plurality of data lines and a plurality of scan lines. Thus, a plurality of electron-emitter elements 1a are placed in a matrix form. On the front substrate, phosphor (not shown) is placed at a position where it faces each electron-emitter element.

The scan drivers 2 and 3 are connected to the scan lines 31 of the display panel 1. The reason why the scan drivers 2 and 3 are placed to the left and right of the display panel 1 is to reduce a luminance gradation due to a voltage drop caused by a resistance which the scanning lines have. The embodiment provides a system in which scan signals are simultaneously supplied to the left and right scan lines by the two scan drivers 2 and 3. On the basis of a scan control signal Sscan as a timing signal from the timing controller 7, the scan drivers 2 and 3 output selection signals (scan signals) for selecting a plurality of electron-emitter elements 1a on a row unit basis (one or two rows). The selection signals are sequentially applied to the scan lines in the column direction and the selecting operations of the rows are successively executed. Thus, the scan lines are sequentially scanned in the column direction.

To reduce erroneous light-on caused by pulse noises due to a coupling capacitance of the scan lines and the data lines, the data lines of the display panel 1 are divided into an upper region and a lower region of a display screen of the display panel. The divided display screen upper region and display screen lower region are individually driven. The data driver 4 is connected to the data lines 32 in the display screen upper region. The data driver 5 is connected to the data lines 33 in the display screen lower region.

Video data outputted from the timing controller 7 is supplied to the data drivers 4 and 5. The data drivers 4 and 5 supply drive signals based on the video data to the electron-emitter elements of one row through the data lines 32 or 33 in correspondence to the row selection by the scan drivers 2 or 3. On the basis of the timing signals from the timing controller 7, the data drivers 4 and 5 hold the data of one row of the display panel 1, that is, the video data of one line from the timing controller for one horizontal period of time and rewrite the data every horizontal period. The drive signals are supplied from the data driver 4 in the display period of time of the display screen upper region. The drive signals are supplied from the data driver 5 in the display period of time of the display screen lower region.

The high voltage generating circuit 6 for generating an acceleration voltage (for example, 7 kV) to accelerate the electron from the electron-emitter element 1a is connected to an anode line 34 of the display panel 1. The electron from the electron-emitter element 1a is accelerated from the rear substrate side (not shown) to the front substrate side by the acceleration voltage.

The operation regarding the display in the display panel constructed as mentioned above will now be described hereinbelow. When the drive signal is supplied from the data driver 4 (5) through the data lines 32 (33) to the electron-emitter elements 1a of one row to which the selection signals have been supplied through the scan lines 31 by the scan drivers 2 and 3, the electron-emitter elements of such a row emit the electrons of an amount according to a potential difference between the selection signal and the drive signal. Since a level of the selection signal which is applied upon selection is constant irrespective of the position of the electron-emitter element, an electron emission amount from the electron-emitter element changes depending on a level of the drive signal. That is, the electron emission amount is determined by a level of the video signal serving as a base of the drive signal. The acceleration voltage (for example, 7 kV) from the high voltage generating circuit 6 has been applied to the anode line 34 of the display panel 1. Therefore, the electron emitted from the electron-emitter element is accelerated by the acceleration voltage and collides with phosphor placed to the front substrate of the display panel 1. Phosphor excites due to the collision of the accelerated electron and emits light. Thus, a video image of the selected one horizontal line is displayed. Further, the scan drivers 2 and 3 sequentially apply the selection signals to a plurality of scan lines in the column direction, thereby selecting the electron-emitter elements every row. Thus, a video image of one frame can be formed on the display surface of the display panel 1.

The operations of the video signal processing circuit 9, the non-display period extending circuit 8, and the timing controller 7 will now be described.

First, the video signal inputted to the video signal terminal 10 is inputted to the video signal processing circuit 9. The video signal processing circuit 9 executes a format conversion of the number of pixels of the signal, a frequency of a sync signal, or the like to the inputted video signal so that a video image corresponding to the video signal can be displayed on the display panel 1 in which the electron-emitter elements are placed in a matrix form.

The video signal which was format-converted by the video signal processing circuit 9 is inputted to the non-display period extending circuit 8. The non-display period extending circuit 8 extends the non-display period (for example, vertical blanking period: hereinbelow, referred to as a vertical non-display period) of the input video signal. A method of extending the vertical non-display period will be described hereinafter. Although the video signal processing circuit 9 and the non-display period extending circuit 8 have been disclosed as different constructions in the embodiment, it is also possible to allow a format converting unit of the video signal processing circuit 9 to have a function of extending the non-display period. The video signal whose non-display period has been extended by the non-display period extending circuit 8 and the sync signals (a horizontal sync signal and a vertical sync signal) of the video signal are supplied to the timing controller 7.

The timing controller 7 forms the scan control signal Sscan as a timing signal and supplies it to the scan drivers 2 and 3. The scan control signal Sscan is the timing signal for controlling in such a manner that the scan drivers 2 and 3 can select a plurality of scan lines one by one and scan. The timing controller 7 replaces the data of the inputted video signal synchronously with the generation of the scan control signal Sscan and outputs the replaced data to the data drivers 4 and 5. In the embodiment, the display panel 1 is divided into the two regions such as display screen upper region and display screen lower region. The replacement of the pixel data to divide the display screen into the upper and lower regions and display the video image thereon is performed by the timing controller 7. The extension of the vertical non-display period can be also realized in the replacement of the pixels by the timing controller 7.

The timing controller 7 has a pulse signal generating function of generating a pulse signal which applies a bias voltage in the reverse direction to the electron-emitter element in order to prevent charges from being accumulated in an insulating layer (or a layer which functions in place of the insulating layer) constructing the electron-emitter element. Since the pulse signal has a reverse polarity opposite to that of the selection voltage mentioned above, there is also a case where it is called a reverse polarity signal hereinbelow. The timing controller 7 also has a reverse polarity signal period extending function (which will be explained in detail hereinafter) of extending a pulse width of the pulse signal so as to have the pulse width longer than the vertical non-display period of the input video signal (before it is extended) within the vertical non-display period extended by the non-display period extending circuit 8.

In the embodiment, the timing controller 7 generates the scan control signal Sscan in the display period of one frame period, generates the pulse signal having a predetermined voltage in the extended vertical non-display period of one frame period, and supplies them to the scan drivers 2 and 3. The scan drivers 2 and 3 switch the scan control signal Sscan from the timing controller 7 in the display period and sequentially supply the foregoing selection signals to the scan lines at one horizontal period. In the vertical non-display period, the scan drivers 2 and 3 supply the reverse polarity signal as a pulse signal mentioned above to all of the scan lines. Naturally, it is also possible that the scan drivers 2 and 3 adjust so that a voltage value of the pulse signal from the timing controller 7 is equal to a predetermined voltage value.

As mentioned above, a polarity of the pulse signal is set to the polarity in the reverse direction opposite to that of the voltage which is applied at the time of the normal operation of the electron-emitter element. That is, in the vertical non-display period of the video signal, since a reverse-directional bias is applied to the electron-emitter element, the voltage which is applied to the electron-emitter element at this time is applied in the reverse direction opposite to the ordinary direction. Therefore, in the vertical non-display period of the video signal, the charges accumulated in the electron-emitter element are emitted. Consequently, the deterioration of the electron-emitter element due to the accumulated charges can be prevented or lightened. The long lifetime of the electron-emitter elements and the long lifetime of the display apparatus can be accomplished.

As mentioned above, the timing controller 7 supplies the scan line selection signals to the scan lines through the scan drivers 2 and 3 for the display period of the video signal. The timing controller 7 supplies the pulse signals of the reverse polarity for the vertical non-display period of the video signal. In the example mentioned above, the apparatus is constructed in such a manner that the pulse signals are supplied to all scan lines (that is, all of the electron-emitter elements) in the vertical non-display period of one frame. However, it is also possible to construct in such a manner that by dividing the scan lines into a few to tens of lines and sequentially supplying the pulse signals at interval of a few to tens of frames on a unit basis of the divided plural lines, the pulse signals are supplied to all of the scan lines for, for instance, one second.

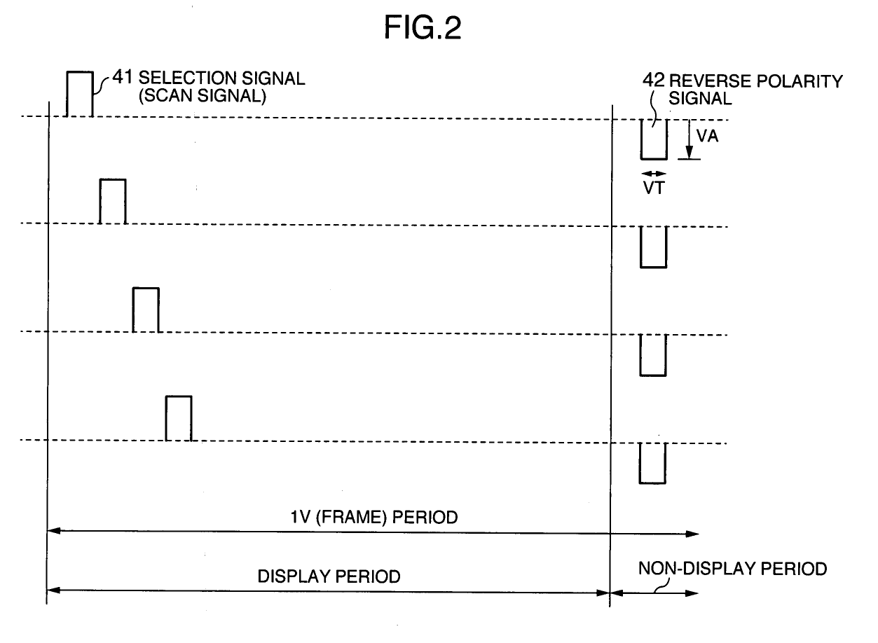

Operation waveforms of the selection signal and the reverse polarity signal as a pulse signal are shown in FIG. 2. As shown in FIG. 2, during the display period of time of the video image in one frame period (hereinafter, referred to as a “1V period”) of the video image, in order to select the electron-emitter elements of each row, the scan drivers 2 and 3 sequentially shift a selection signal 41 every row in the column direction from the scan line in the upper portion of the display screen and supply the shifted selection signal 41 to the scan lines. In the vertical non-display period (vertical blanking period) of the video image, the reverse polarity signal having the polarity different from that of the selection signal is supplied from the timing controller 7, and the scan drivers 2 and 3 simultaneously supply a reverse polarity signal 42 to all of the scan lines. Thus, the charges accumulated in the insulating layer in the electron-emitter element are emitted in the 1V period.

To preferably eliminate the charges accumulated in the insulating layer in the electron-emitter element, the reverse polarity signal needs to have predetermined pulse width VT and pulse amplitude VA. That is, an eliminating effect of the accumulated charges by the reverse polarity signal is determined by the product (that is, pulse area) of the pulse width VT and pulse amplitude VA of the reverse polarity signal. To enhance the eliminating effect of the accumulated charges, there is a method of increasing the pulse amplitude VA. However, in this case, there is a possibility that the pulse amplitude VA exceeds a withstanding voltage against the reverse-directional bias of the electron-emitter element and there is a risk of breakdown of the electron-emitter element. In the embodiment, to allow the apparatus to have the eliminating effect of the accumulated charges that is equivalent to the process for increasing the pulse amplitude VA, the pulse amplitude VA is not increased (suppressed to a value which is equal to or less than the withstanding voltage) but the pulse width VT is increased. To further enhance the eliminating effect of the accumulated charges, it is desirable to further increase the pulse width VT. However, if the reverse polarity signal is supplied to the electron-emitter element over the vertical non-display period (that is, over the display period), the display video mage is influenced. Therefore, it is necessary to set the pulse width VT to a value within the vertical non-display period of the video image. In the embodiment, therefore, the pulse width VT of the reverse polarity signal can be further increased by a method whereby the vertical non-display period of the video signal which is supplied to the electron-emitter element is set to be longer than the vertical non-display period of the input video image. The pulse width VT of the reverse polarity signal in the embodiment is set to be longer than the vertical non-display period of the input video image.

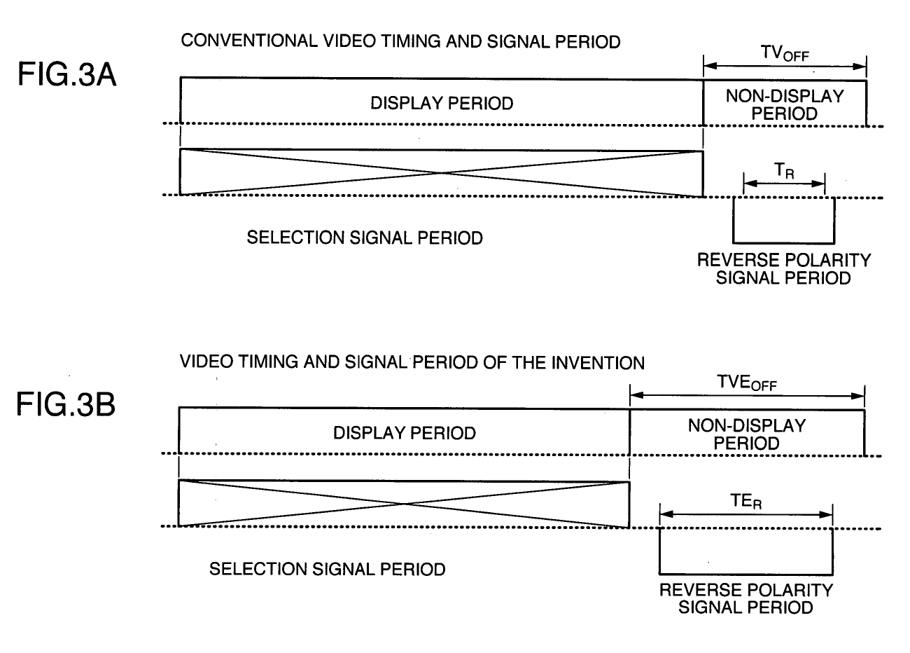

A concept of the method of extending the vertical non-display period of the video signal will now be described with reference to FIGS. 3A and 3B. FIG. 3A is a diagram showing a relation between a display/non-display period of the 1V period and a selection signal period/reverse polarity signal period disclosed in, for example, Patent Document 1. FIG. 3B is a diagram showing a relation between a display/non-display period and a selection signal period/reverse polarity signal period according to the invention. That is, in the embodiment, as shown in FIG. 3B, the display period of the video image is shortened, a vertical non-display period TVE_{OFF} is set to be longer than a conventional vertical non-display period TV_{OFF} of the video image by the time corresponding to the shortened display period, and a reverse polarity signal period TE_{R} is extended. The vertical non-display period TV_{OFF} and a reverse polarity signal period T_{R} in the conventional apparatus and the extended vertical non-display period TVE_{OFF} and the extended reverse polarity signal period TE_{R} in the embodiment satisfy the following inequality (1).
TVE_{OFF}>TE_{R}>TV_{OFF}>T_{R} (1)

A duration of the vertical non-display period (vertical blanking period) TV_{OFF} of the input video signal is obtained by the following expression (2)
(N−E)/(N·FV) (2)
when the total number of scan lines per 1V of the input video signal is assumed to be N, the number of valid scan lines is assumed to be E, and a vertical frequency is assumed to be FV.

For example, if the input video signal is for a standard TV, since (N=525, E=480, and FV=60), TV_{OFF} is equal to about 1.428 [msec]. That is, in the embodiment, if the input video signal is the standard TV signal, the pulse width TE_{R} of the reverse polarity signal is set to be longer than 1.428 [msec]. In the case of the HDTV signal whose degree of fineness is higher than that of the standard TV signal, for example, (N=1125, E=1080, and FV=60). In this case, TV_{OFF} is equal to about 0.667 [msec]. In the embodiment, therefore, if the input video signal is the HDTV signal, the pulse width TE_{R} of the reverse polarity signal is set to be longer than 0.666 [msec]. If the display apparatus can cope with those two kinds of television signals, the pulse width TE_{R} of the reverse polarity signal can be variably controlled by the timing controller 7 in accordance with the kind of input video signal. That is, the timing controller 7 variably controls the pulse width TE_{R} of the reverse polarity signal in such a manner that TE_{R} is set to be longer than 1.428 [msec] when the input video signal is the standard TV signal and TE_{R} is set to be longer than 0.666 [msec] when the input video signal is the HDTV signal.

When the input video signal is a digital TV signal, the digital TV signal is decoded and, thereafter, the vertical non-display period is formed. In the embodiment, therefore, when the input signal is the digital TV signal, the pulse width TE_{R} of the reverse polarity signal is set to be longer than the vertical non-display period of the decoded digital TV signal.

In the above example, the vertical non-display period TVE_{OFF} and the reverse polarity signal period TE_{R} are set to the optimum values in accordance with the pulse amplitude VA of the reverse polarity signal. For example, the apparatus preliminarily has a table of the vertical non-display periods TVE_{OFF} and the reverse polarity signal periods TE_{R} corresponding to a plurality of pulse amplitude values of the reverse polarity signal and designates the pulse amplitude value of the reverse polarity signal by input means or a menu display screen (not shown). Thus, the optimum vertical non-display period TVE_{OFF} and reverse polarity signal period TE_{R} corresponding to the designated pulse amplitude value of the reverse polarity signal can be read out of the table and set.

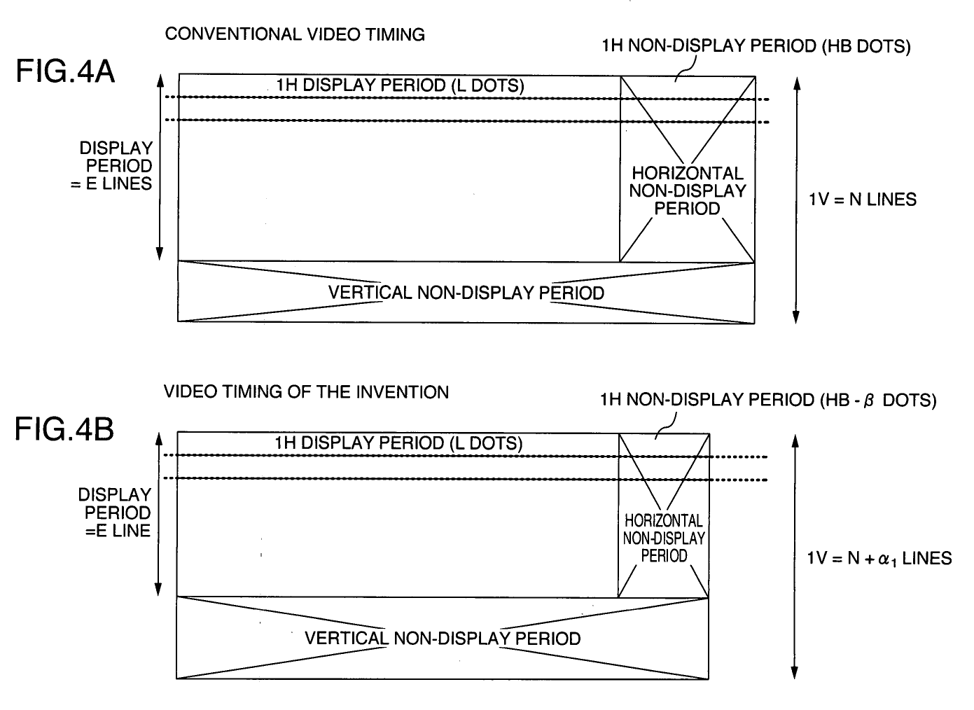

The method of extending the vertical non-display period of the video image will now be specifically explained with reference to FIGS. 4A and 4B. FIG. 4A shows the conventional video timing. FIG. 4B shows the video timing according to the embodiment. Also in the conventional technique and the embodiment, it is assumed that the 1V period (1 frame period) of the video image and time of one dot of the video image (generally, time of a clock which is used for the 1-dot video display) are not changed.

In FIG. 4A, it is assumed that the total number of lines of the 1V period is equal to N lines, the number of lines of the display period of the 1V period is equal to E lines, the display period of one horizontal line (hereinafter, abbreviated to “1H”) is constructed by L dots, and the non-display period (horizontal non-display period) of 1H is constructed by HB dots. It is also assumed that dots of (E lines×L dots) corresponding to the display period of the video image are displayed on the display panel 1.

In FIG. 4B according to the embodiment, the non-display period (the number of dots is equal to HB) of 1H is reduced by β dots. Unlike a CRT (cathode ray tube) which is scanned in the row direction, in the display panel using the electron-emitter elements, simultaneously with the row selection, the display data of the selected row is given in a lump as mentioned above. Therefore, at the time of the horizontal scan, the 1H non-display period (horizontal blanking period) provided to return an electron beam from an electron gun to a start position is unnecessary. Even if the 1H non-display period is shortened, no troubles occur. Since the number of dots (L) of the display period of 1H is not changed, there are no problems with respect to the video display.

By reducing the non-display period of 1H by β dots, the total number of dots of 1H (the number of dots of the 1H display period+1H non-display period) is also decreased by β dots. Thus, the total time of 1H also becomes short. Since the number of dots of each line is reduced by β dots in all of the E lines, the display period of the 1V period can be shortened by the time corresponding to (E lines×β dots). Therefore, the vertical non-display period can be extended by the time corresponding to the shortened display period. When the number of lines caused by shortening the non-display period of 1H is assumed to be α₁ lines, the vertical non-display period can be extended by the time corresponding to the α₁ lines. Consequently, the pulse width of the reverse polarity signal can be also increased by the value corresponding to the α₁ lines.

The foregoing process to extend the vertical non-display period is executed by the non-display period extending circuit 8. Specifically speaking, the non-display period extending circuit 8 has a frame memory therein and executes the extending process of the vertical non-display period by controlling the writing/reading operations into/from the frame memory. That is, the video data of the input video signal is written into the frame memory by an amount corresponding to one horizontal line and when the video data of one horizontal line is read out of the frame memory, the number of reading clocks is set to be smaller than the number of writing clocks of the video data corresponding to the horizontal non-display period. For example, if the number of reading clocks of the video data corresponding to the horizontal non-display period is set to the half of the number of writing clocks (that is, a reading clock frequency in the horizontal non-display period is set to a value which is two times as high as a writing clock frequency), the horizontal non-display period of the video data read out of the frame memory can be set to ½ of the horizontal non-display period of the input video signal. In this example, if the input video signal is the standard TV signal, the vertical non-display period in the 1V period can be extended by the time shown by (the horizontal blanking period/2×525). In the extended vertical non-display period, the process or control to extend the vertical non-display period to the period longer than the pulse width of the reverse polarity signal is executed by the timing controller 7.

As mentioned above, in the embodiment, the pulse width of the reverse polarity signal can be increased by extending the vertical non-display period of the input video signal. Therefore, the reverse polarity signal can be supplied to the electron-emitter element for the time longer than the vertical non-display period of the original input video signal. Therefore, according to the embodiment, while the pulse amplitude of the reverse polarity signal is set to a value which is sufficiently lower than the breakdown voltage of the thin-film type electron-emitter element, the reverse polarity signal can be supplied to the electron-emitter element for a relatively long time, so that the charges accumulated in the insulating layer of the thin-film type electron-emitter element can be preferably eliminated. Therefore, the reliability of the thin-film type electron-emitter element and the display apparatus using those elements can be improved and their lifetimes can be extended.

### Embodiment 2

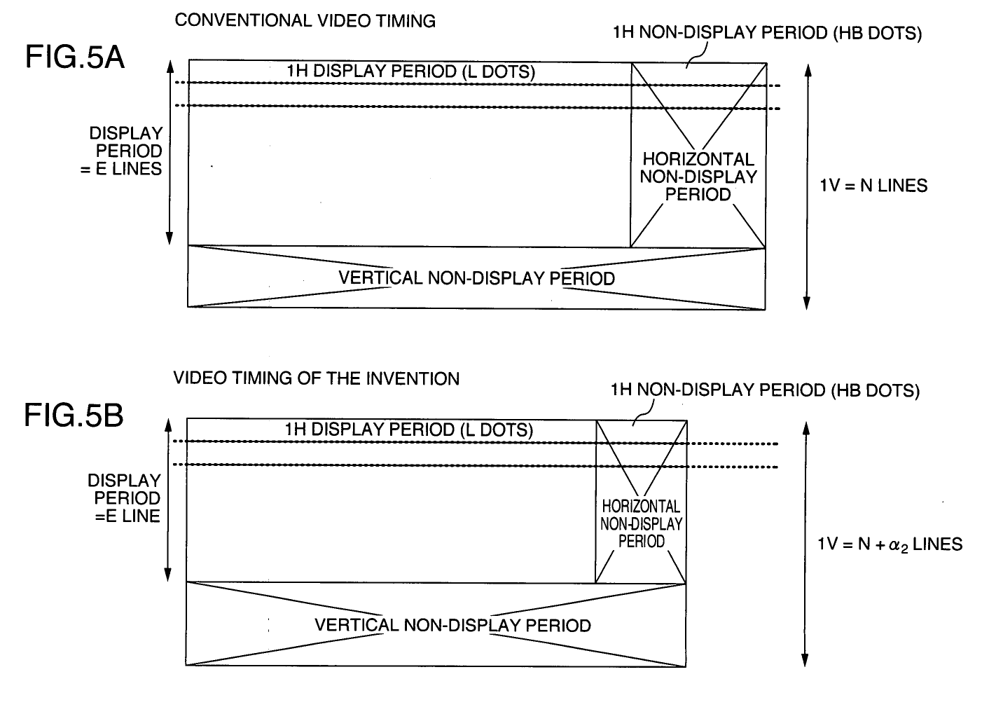

The second embodiment to extend the vertical non-display period of the video image will now be described with reference to FIGS. 5A and 5B. A block diagram of a display apparatus according to the second embodiment is substantially the same as that of FIG. 1. Also in the embodiment, component elements having common functions are designated by the same reference numerals and their explanation is omitted.

FIG. 5A shows conventional video timing. FIG. 5B shows video timing according to the embodiment. It is assumed that, in the conventional technique and the embodiment, the 1V period (1 frame period) of the video image is not changed. In a manner similar to FIG. 4A, FIG. 5A is illustrated to show a difference from the embodiment and its explanation is omitted.

Unlike the first embodiment in which the number of dots in the 1H non-display period is reduced, according to the embodiment, as shown in FIG. 5B, the number of dots (L) of the display period of 1H and the number of dots (HB) of the non-display period (horizontal non-display period) of 1H are not changed but the 1-dot period is shortened. Therefore, the total 1H period (1H display period+1H non-display period) is shortened by the time corresponding to the shortened period of one clock. Since the number of dots (L) of the display period of 1H and the number of lines (E) of the display period of the 1V period are not changed, no problems occur with respect to the video display. With respect to the E lines in the display period of the 1V period, the display period of the 1V period can be shortened by the time corresponding to the shortened total 1H period. Therefore, the vertical non-display period can be extended by the time corresponding to the shortened display period. When the number of lines caused by shortening the 1-dot period is assumed to be α₂ lines, the vertical non-display period can be extended by the time corresponding to the α₂ lines. Thus, the pulse width of the reverse polarity signal can be also increased by the value corresponding to the α₂ lines.

The foregoing process to extend the vertical non-display period by shortening the 1-dot period is executed by the non-display period extending circuit 8. Generally, the shortening of the display period of the 1V period can be easily realized by changing the writing clocks and the reading clocks of the memory. Specifically speaking, the non-display period extending circuit 8 has the frame memory therein and executes the extending process of the vertical non-display period by controlling the writing/reading operations into/from the frame memory. That is, the video data of the input video signal is written into the frame memory by the amount corresponding to one horizontal line and when the video data of one horizontal line is read out of the frame memory, the reading clock frequency is set to be higher than the writing clock frequency. For example, the reading clock frequency is set to a value which is 1.2 times as high as the writing clock frequency. Therefore, one horizontal period (and 1-dot period) of the video data read out of the frame memory is time-base compressed to a value which is 1/1.2 time as large as one horizontal period of the written video data. Thus, the vertical non-display period can be extended by the time corresponding to the product of the horizontal period which has been time-base compressed to the value of 1/1.2 time and the total number of lines. Naturally, the conversion of the clock frequency can be also executed in the format converting unit of the video signal processing circuit 9 and in the memory of the data replacing unit of the timing controller 7. In a manner similar to the first embodiment, according to the second embodiment, in the extended vertical non-display period, the process or control to extend the vertical non-display period to the period longer than the pulse width of the reverse polarity signal is also executed by the timing controller 7.

Although an effect similar to that of the first embodiment can be also obtained in the embodiment, according to the embodiment, such an effect can be realized by raising the reading clock frequency of the frame memory. Therefore, the extending process of the vertical non-display period can be executed by a construction simpler than that in the first embodiment.

### Embodiment 3

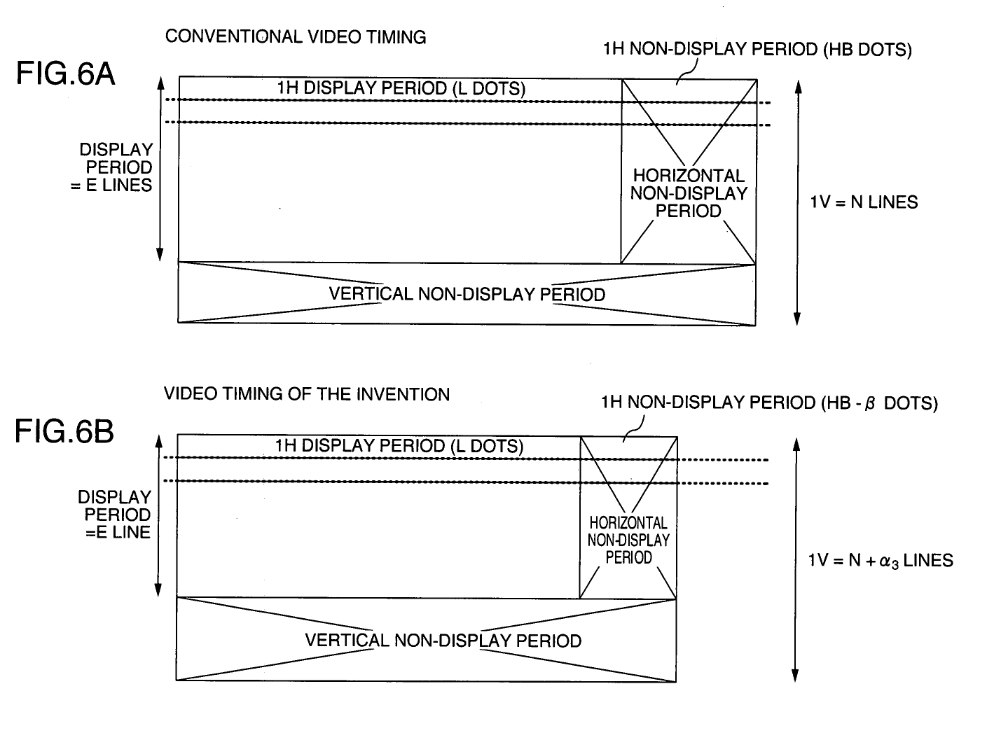

The third embodiment to extend the vertical non-display period of the video image will now be described with reference to FIGS. 6A and 6B. A block diagram of a display apparatus according to the embodiment is substantially the same as that of FIG. 1. Also in the embodiment, component elements having common functions are designated by the same reference numerals and their explanation is omitted.

FIG. 6A shows conventional video timing. FIG. 6B shows video timing according to the embodiment. It is assumed that, in the conventional technique and the embodiment, the 1V period (1 frame period) of the video image is not changed. In a manner similar to FIG. 4A, FIG. 6A is illustrated to show a difference from the embodiment and its explanation is omitted.

The third embodiment relates to a combination of the first and second embodiments. As shown in FIG. 6B, the 1-dot period is shortened and the number of dots (HB) of the non-display period (horizontal non-display period) of 1H is reduced by β dots. Since the number of dots (L) of the display period of 1H is not changed, no problems occur with respect to the video display.

Since the 1H period becomes short by shortening the 1-dot period, the display period of the 1V period can be shortened and the vertical non-display period can be extended by the time corresponding to the shortened display period. In addition, since the number of dots of the non-display period of 1H is reduced by β dots, the display period of the 1V period can be further shortened and the vertical non-display period can be extended by the time corresponding to the shortened display period. When the number of lines caused by the above process is assumed to be α₃ lines, the vertical non-display period can be extended by the time corresponding to the α₃ lines. Thus, the pulse width of the reverse polarity signal can be also increased by the value corresponding to the α₃ lines. In a manner similar to the first and second embodiments, according to the third embodiment, in the extended vertical non-display period, the process or control to extend the vertical non-display period to the period longer than the pulse width of the reverse polarity signal is also executed by the timing controller 7. An effect similar to that in each of the first and second embodiments can be also obtained in the embodiment. As compared with the first and second embodiments, the vertical non-display period can be extended more and, at the same time, the pulse width of the reverse polarity signal can be further extended.

### Fourth Embodiment

In the first to third embodiments mentioned above, the non-display period extending circuit 8 to extend the vertical non-display period and the timing controller 7 to control the generation of the reverse polarity signal and its pulse width are independently constructed. However, the invention is not limited to such a construction. That is, it is also possible to allow the timing controller 7 to have the function of the non-display period extending circuit 8.

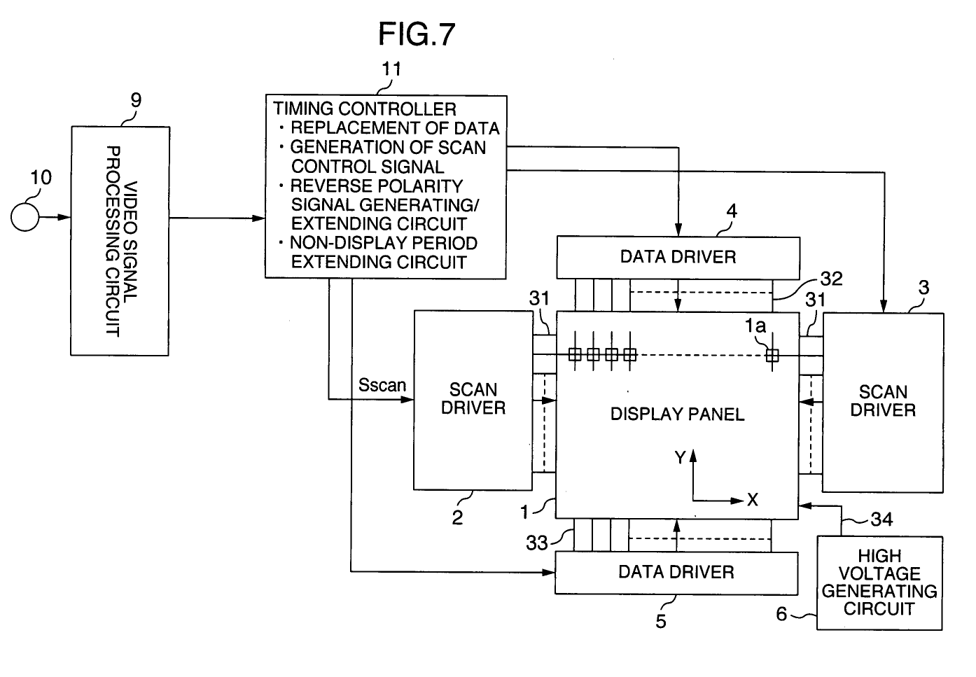

FIG. 7 is a block diagram according to the embodiment. A timing controller 11 has a function of executing the operation to extend the vertical non-display period of the input video signal. In FIG. 7, component elements having the same functions as those in FIG. 1 are designated by the same reference numerals and their description is omitted.

In FIG. 7, the video signal inputted to the video signal terminal 10 is supplied to the video signal processing circuit 9, by which the number of pixels, the frequencies of the sync signals, and the like are format-converted so that the video image can be displayed by the display panel 1, and the converted signal is inputted to the timing controller 11.

The timing controller 11 forms the scan control signal Sscan and supplies it to the scan drivers 2 and 3. Further, synchronously with it, the inputted video data is replaced so that the video image can be displayed on the display panel 1, and the replaced video data is outputted to the data drivers 4 and 5. The video image is displayed on the display panel 1 through the data drivers 4 and 5 and the scan drivers 2 and 3. The timing controller 11 has the foregoing function of forming the reverse polarity signal and the function of extending the vertical non-display period of the input video signal. The timing controller 11 further has the function of extending the pulse width of the reverse polarity signal to a value longer than the vertical non-display period of the input video signal in correspondence to the extension of the vertical non-display period. Since the extension of the vertical non-display period and the extending process of the pulse width of the reverse polarity signal are similar to those described in the first embodiment, its explanation is omitted.

According to the embodiment, an effect similar to that in the first embodiment mentioned above can be obtained while simplifying the circuit construction.

As described above, according to the embodiment of the invention, the pulse width of the reverse polarity signal can be increased by extending the vertical non-display period of the input video signal. Therefore, the reverse polarity signal can be supplied to the electron-emitter element for the time longer than the vertical non-display period of the original input video signal. Therefore, according to the embodiment, while the pulse amplitude of the reverse polarity signal is set to a value which is sufficiently lower than the breakdown voltage of the thin-film type electron-emitter element, the reverse polarity signal can be supplied to the electron-emitter element for a relatively long time, so that the charges accumulated in the insulating layer of the thin-film type electron-emitter element can be preferably eliminated. Therefore, the reliability of the thin-film type electron-emitter element and the display apparatus using those elements can be improved and their lifetimes can be extended.

It should be further understood by those skilled in the art that although the foregoing description has been made on embodiments of the invention, the invention is not limited thereto and various changes and modifications may be made without departing from the spirit of the invention and the scope of the appended claims.

1. A display apparatus comprising:
a plurality of electron-emitter elements for emitting electrons in accordance with a video signal;
a pulse applying circuit for applying a pulse signal to said electron-emitter elements in a non-display period of said video signal; and
a controller for controlling a pulse width of said pulse signal from said pulse applying circuit.

2. An apparatus according to claim 1, wherein the non-display period of said video signal is a vertical blanking period of said video signal.

3. An apparatus according to claim 1, further comprising a scan driver for forming a selection voltage to select said electron-emitter elements on a row unit basis, and wherein said scan driver includes said pulse applying circuit and the pulse signal from said pulse applying circuit has a reverse polarity opposite to that of said selection voltage.

4. An apparatus according to claim 1, wherein said controller controls the pulse width of said pulse signal in accordance with a kind of said video signal.

5. An apparatus according to claim 1, wherein said electron-emitter element is a thin-film type electron-emitter element and eliminates charges accumulated in said thin-film type electron-emitter element by said pulse signal.

6. A display apparatus comprising:
a non-display period extending circuit for extending a non-display period of an input video signal to a period longer than the non-display period of said input video image and outputting the extended signal;
a plurality of electron-emitter elements for emitting electrons on the basis of the video signal outputted from said non-display period extending circuit; and
a pulse applying circuit for applying a pulse signal to said electron-emitter elements in the non-display period of said video signal extended by said non-display period extending circuit.

7. A display apparatus comprising:
a non-display period extending circuit for extending a non-display period of an input video signal to a period longer than the non-display period of said input video image and outputting the extended signal;
a plurality of electron-emitter elements for emitting electrons on the basis of the video signal outputted from said non-display period extending circuit; and
a pulse applying circuit for applying a pulse signal to said electron-emitter elements in the non-display period of said video signal extended by said non-display period extending circuit,
wherein a pulse width of the pulse signal from said pulse applying circuit is longer than at least the non-display period of said input video signal.

8. An apparatus according to claim 7, wherein the non-display period of said video signal is a vertical blanking period of said video signal, and
the pulse width of the pulse signal from said pulse applying circuit is longer than the vertical blanking period of said input video signal.

9. An apparatus according to claim 7, further comprising a controller for controlling said pulse width so as to set the pulse width of the pulse signal from said pulse applying circuit to be longer than at least the non-display period of said input video signal.

10. A display apparatus comprising:
a non-display period extending circuit for extending a non-display period of an input video signal to a period longer than the non-display period of said input video image and outputting the extended signal;
a plurality of electron-emitter elements for emitting electrons on the basis of the video signal outputted from said non-display period extending circuit;
a pulse applying circuit for applying a pulse signal to said electron-emitter elements in the non-display period of the video signal from said non-display period extending circuit; and
a controller for controlling a pulse width of the pulse signal from said pulse applying circuit in accordance with a kind of said input video signal.

11. An apparatus according to claim 10, wherein said controller controls in such a manner that when said input video signal is a standard television signal, the pulse width of the pulse signal from said pulse applying circuit becomes longer than 1.428 [msec], and when said input video signal is a high-definition television signal whose degree of fineness is higher than that of said standard television signal, the pulse width of the pulse signal from said pulse applying circuit becomes longer than 0.666 [msec].

12. A display apparatus comprising:
a vertical non-display period adjusting circuit for extending a vertical non-display period of a video signal which is inputted to said display apparatus;
a plurality of electron-emitter elements placed in a matrix form for emitting electrons on the basis of the video signal in which said vertical non-display period has been extended;
a plurality of scan lines connected to said electron-emitter elements placed in the row direction;
a plurality of data lines connected to said electron-emitter elements placed in the column direction;
a scan driver for supplying a selection signal to sequentially select said electron-emitter elements in the column direction on a row unit basis to said scan lines;
a data driver for supplying a drive signal, based on the video signal, for driving said electron-emitter elements to each of said plurality of data lines; and
a reverse polarity signal generating circuit for supplying a reverse polarity signal whose polarity differs from that of the selection signal which is supplied to said plurality of scan lines to said electron-emitter elements in said extended vertical non-display period.

13. An apparatus according to claim 12, wherein an output period of said reverse polarity signal is longer than the vertical non-display period of the video signal before it is extended by said vertical non-display period adjusting circuit.

14. An apparatus according to claim 13, wherein said reverse polarity signal generating circuit controls a generating period of said reverse polarity signal in accordance with an amplitude of said reverse polarity signal.

15. An apparatus according to claim 12, wherein said vertical non-display period adjusting circuit shortens a horizontal non-display period of the video signal which is inputted to said display apparatus.

16. An apparatus according to claim 12, wherein said vertical non-display period adjusting circuit extends said vertical non-display period by shortening a horizontal active video period and a horizontal non-display period of the video signal which is inputted to said display apparatus by a period of one dot of both of said horizontal active video period and said horizontal non-display period.

17. An apparatus according to claim 12, wherein said vertical non-display period adjusting circuit extends said vertical non-display period by shortening a horizontal active video period and a horizontal non-display period of the video signal which is inputted to said display apparatus by a period of one dot of both of said horizontal active video period and said horizontal non-display period and by reducing number of dots in one of the horizontal non-display period of the video signal which is inputted to said display apparatus.
